(19) United States
(12) Patent Application Publication
(10) Pub. No.: US 2024/0186516 A1
(43) Pub. Date: Jun. 6, 2024

(54) SULFUR-LOADED CONDUCTIVE POLYMER FOR HIGH ENERGY DENSITY LITHIUM SULFIDE BATTERY

(71) Applicant: DREXEL UNIVERSITY, Philadelphia, PA (US)

(72) Inventors: Krishna Kumar Sarode, Telangana (IN); Vibha Kalra, Garnet Valley, PA (US)

(73) Assignee: DREXEL UNIVERSITY, Philadelphia, PA (US)

(21) Appl. No.: 18/556,588

(22) PCT Filed: Apr. 25, 2022
(86) PCT No.: PCT/US2022/071890

§ 371 Date: Oct. 20, 2023

Related U.S. Application Data
(60) Provisional application No. 63/178,734, filed on Apr. 23, 2021.

(51) Int. Cl. H01M 4/60; C08K 3/06; C08L 33/20; H01M 4/02; H01M 4/137; H01M 4/62; H01M 10/052; H01M 10/0569

(52) U.S. Cl. CPC H01M 4/604; C08K 3/06; C08L 33/20; H01M 4/137; H01M 4/606; H01M 4/622; H01M 4/625; H01M 10/052; H01M 10/0569; C08L 2203/20; H01M 2004/021; H01M 2004/028

(57) ABSTRACT

Methods of making a cathode active material, including steps of: a) mixing a conductive polymer, a nitrogen containing polymer or a combination of a conductive polymer and a nitrogen-containing polymer with sulfur in the presence of a solvent to form a mixture, using a weight ratio of the conductive polymer and/or nitrogen containing polymer to the sulfur of from about 1:2 to about 1:8; and b) heating the mixture to a temperature of from about 250#C to about 400#C under a pressure of from about 0.05 bar to about 2.0 bar to form the cathode active material. A cathode active material formed by the method and cells and batteries employing the cathode active material.

### CROSS-REFERENCE TO RELATED APPLICATIONS'

This application claims the benefit if U.S. provisional application No. 63/178,734 filed on Apr. 23, 2021, the entire disclosure of which is hereby incorporated by reference herein.

### BACKGROUND OF THE INVENTION

The work on developing new kinds of batteries including a more stable conductive polymer-sulfur composite cathode and a Li-metal anode has been motivated by numerous scientific and technical challenges due to the requirement for safe, stable and high energy-power batteries for use in high energy applications and reducing greenhouse gas emissions. For example, current Li-ion batteries typically have an energy density ranging from 220 W-h/kg of the battery to 250 W-h/kg of the battery, which is not sufficient for high energy applications, such as powering electric vehicles and grid energy storage. Moreover, the use of toxic and rare materials in such batteries increases cost and adversely effects the environment. Accordingly, there is a strong need for batteries with improved energy densities of approximately 500 W-h/kg of the battery, using non-toxic, inexpensive and abundant raw materials.

Lithium-sulfur batteries are promising for high energy applications because of their relatively high theoretical energy density (approximately 2600 W-h/kg of the battery). Challenges that limit the practical application of Li—S batteries include the insulating nature of sulfur³, low sulfur loadings, dissolution of polysulfides and shuttling. Other drawbacks, such as, dendrite formation on Li-metal⁶ and use of low boiling solvents (for example, dioxolane and dimethoxy ethane), also contribute to the barriers to practical realization of Li—S batteries⁷. Additionally, high surface area carbon materials used to support the sulfur require a high electrolyte content for obtaining optimized performance, which results in a significant reduction of the resulting battery's energy density⁸.

### SUMMARY OF THE INVENTION

The present disclosure relates to methods involving selective application of pressure onto sulfur and a conductive polymer composite during a heating step to, thereby confine the sulfur within the conductive polymer. The sulfur loading of the polymer can be tuned by controlling the pressure during the heating step.

The present method is capable of confining significant amounts of sulfur within the conductive polymer by application of a pressure of 0.05 bar to 2 bars. For example, sulfur loadings of 50-60 wt. % have been achieved using this method and even higher loadings are achievable. At these high loadings, stable capacities of 620 mAh/g (53 wt. % loading), 660 mAh/g (56 wt. % loading) and 710 mAh/g to 750 mAh/g (60 wt. % loading) were obtained at 0.5 C, all weight percentages being based on the total weight of the composite active material. Stable capacities of 850 mAh/g or higher with loadings of 70 wt. % and above should be achievable at 0.5 C. All capacities are based on a total weight of the cathode active material.

The method of the present disclosure may be employed to provide cathodes that can be used to make batteries with energy densities ranging from 450-500 W-h/kg of the battery or higher. Furthermore, the method of making the active material of the cathode is innovative, simple, and cost effective, as compared to other currently known methods.

In a first aspect, the present invention relates to a method of making a cathode active material. The method may include steps of
a) mixing a conductive polymer, a nitrogen containing polymer or a combination of a conductive polymer and a nitrogen-containing polymer, and sulfur in the presence of a solvent to form a mixture, wherein a weight ratio of the conductive polymer and/or nitrogen containing polymer to the sulfur is from about 1:2 to about 1:8; and
b) heating the mixture to a temperature of from about 250° C. to about 500° C. under a pressure of from about 0.05 bar to about 2.0 bar to form the cathode active material.

In the foregoing method, the heating step may be carried out for about 1 to about 10 hours, or from about 2 to about 8 hours, and/or the mixing step may be carried out for about 1 to about 15 hours or from about 5 to about 10 hours, optionally using wet ball milling to achieve the mixing.

In each of the foregoing embodiments of the method a dopant, which may be selected from magnesium, iron, cobalt, nickel, molybdenum, and iodine and mixtures thereof, may be added to the mixture prior to or during the heating step.

In each of the foregoing embodiments of the method the heating step may be a pyrolysis step.

In each of the foregoing embodiments of the method the pressure in the heating step may be from about 0.1 bar to about 1.5 bars, or about 0.2 bar to about 1.0 bar, or about 0.2 bar to about 0.7 bar, or about 0.3 bar to about 0.6 bar.

Optionally, in any of the foregoing embodiments, gas may be vented during the heating step to control the pressure.

In each of the foregoing embodiments, the cathode active material may have a sulfur loading of at least 35 wt. %, or at least 40 wt. %, or at least 45 wt. % or at least 50 wt. % or at least 53 wt. %, or less than 80 wt. %, or less than 65 wt. %, or no greater than 60 wt. %, with all weight percentages being based on the total weight of cathode active material.

In each of the foregoing embodiments of the method the cathode active material may have a stable capacity of greater than about 450 mAh/g, or greater than about 550 mAh/g, or greater than about 600 mAh/g, or greater than about 620 mAh/g, or less than about 1000 mAh/g, or less than about 850 mAh/g or less than about 800 mAh/g or less than about 750 mAh/g, or from about 600 mAh/g to about 850 mAh/g, all determined at 0.5 C, and based on a total weight of the cathode active material.

In each of the foregoing embodiments of the method the conductive polymer may be selected from polypyrrole, polyyne, polythiophenes, poly(3,4-ethylenedioxythiophene) polystyrene sulfonate (PEDOT), nitrogen-containing polymers, selected from polyamide, polyaniline, and poly(nitroaniline), polyurethane, poly(phenyl sulfide-tetra aniline), and mixtures of two or more of any of these conductive polymers.

In each of the foregoing embodiments of the method a second polymer selected from polyvinyl alcohol, poly(vinylidene fluoride) and mixtures thereof, may be added to the mixture prior to or during the heating step.

In each of the foregoing embodiments of the method a weight ratio of the second polymer to the total weight of the nitrogen-containing polymer and the sulfur may be from about 1:25 to about 1:100.

In each of the foregoing embodiments of the method the solvent may be selected from the group consisting of ethanol, acetonitrile, acetone, isopropanol, dichloromethane, ethyl acetate, ethylene dichloride, heptane, n-propanol and mixtures thereof, and, preferably, the solvent may be ethanol.

In a second aspect, the present invention relates to a cathode active material prepared by any of the foregoing methods.

In a third aspect, the present invention relates to a cathode electrode composite including the cathode active material, conductive carbon black or conductive microporous carbon, and one or more binders that are soluble in the solvent.

In the foregoing embodiment of the cathode electrode composite the one or more binders may be selected from sodium carboxy methyl cellulose (NaCMC), beta cyclodextrin, polyacrylic acid (PAA), polymethacrylic acid, carboxyethyl cellulose, acrylic acid-methacrylic acid copolymer, polyvinylidene fluoride (PVDF), polyvinylidene difluoride (PTFE), and mixtures thereof.

In each of the foregoing embodiments of the cathode electrode composite the cathode active material, the conductive carbon black, and the binder may be present in a ratio of from 60:30:10 to 90:5:5, or a ratio of from about 70:20:10 to 90:5:5, or a ratio of about 80:10:10.

In each of the foregoing embodiments the cathode electrode composite may have a sulfur loading of from about 50 wt. % to about 80 wt. % or from about 65 wt. % to about 75 wt. %, based on the total weight of the cathode electrode composite.

In each of the foregoing embodiments the cathode electrode composite may have a stable capacity of from 500 mAh/g to about 850 mAh/g, at 0.5 C, based on a total weight of the cathode active material.

In each of the foregoing embodiments the cathode electrode composite may include sulfur particles having a particle size ranging from 50 nm-500 nm, or from about 75 nm to about 400 nm, or from 100-250 nm, as measured by a scanning electron microscope (SEM) and Dynamic Light Scattering.

In a fourth aspect, the present invention relates to a sulfur cell comprising the cathode electrode composite of any of the foregoing embodiments, an anode, and an electrolyte.

In the foregoing embodiment of the sulfur cell the electrolyte may be a carbonate electrolyte that is optionally selected from ethylene carbonate, dimethylcarbonate, methylethyl carbonate, diethylcarbonate, propylene carbonate, vinylene carbonate, allyl ethyl carbonate, and mixtures thereof.

In each of the foregoing embodiments of the sulfur cell the anode may be an ion reservoir including an active material selected from alkali metals, alkaline earth metals, transition metals, graphite, alloys, composites and mixtures thereof.

In each of the foregoing embodiments of the sulfur cell the anode may include an active material selected from lithium, sodium, potassium, magnesium, calcium, zinc, copper, titanium, nickel, cobalt, iron, aluminum and mixtures thereof.

In each of the foregoing embodiments of the sulfur cell may be selected from a lithium-sulfur cell, a sodium-sulfur cell, a potassium-sulfur cell, a magnesium-sulfur cell, and a calcium-sulfur cell.

In a fifth aspect, the present invention relates to a battery comprising one or more of the sulfur cells of each of the foregoing embodiments.

In the foregoing embodiment, the battery may have an energy density of greater than 250 W-h/kg of the battery, or greater than 300 W-h/kg of the battery, or greater than 400 W-h/kg of the battery, or greater than 500 W-h/kg of the battery.

Additional details and advantages of the disclosure will be set forth in part in the description which follows, and/or may be learned by practice of the disclosure. The details and advantages of the disclosure may be realized and attained by means of the elements and combinations particularly pointed out in the appended claims. It is to be understood that both the foregoing general description and the following detailed description are exemplary and explanatory only and are not restrictive of the disclosure, as claimed.

### BRIEF DESCRIPTION OF THE DRAWINGS

FIG. 1 shows the cycle life of pouch cells comprising a conductive polymer-sulfur composite made by the method of the present invention with and without metal dopant as the cathode and lithium metal as the anode.

FIG. 2A shows an SEM (Scanning Electron Microscopy) image of a composite synthesized in a partially closed system by the method of the present invention with ethanol wetting.

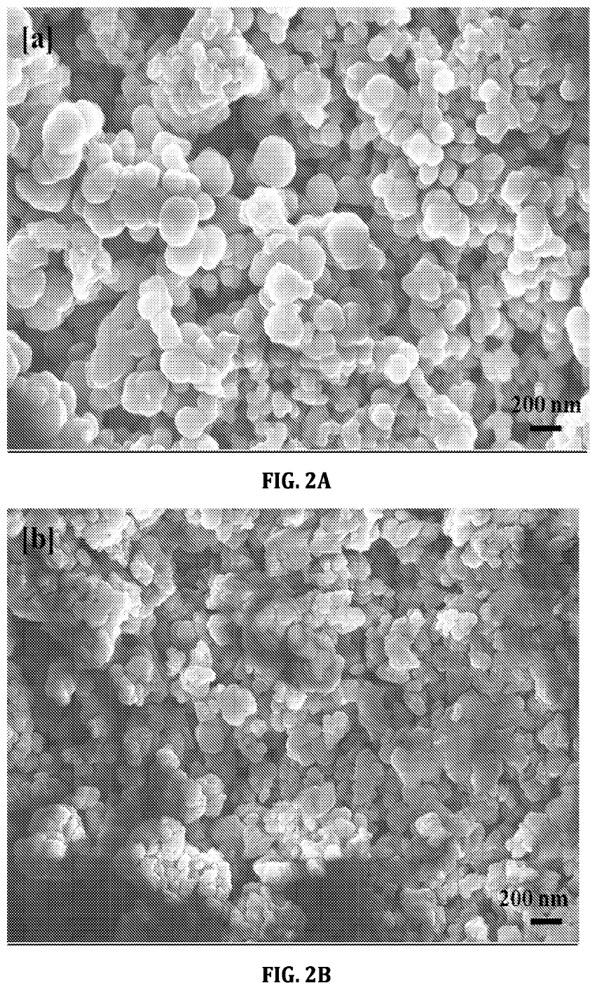

FIG. 2B shows an SEM image of a composite synthesized in a partially closed system by the method of the present invention without ethanol wetting.

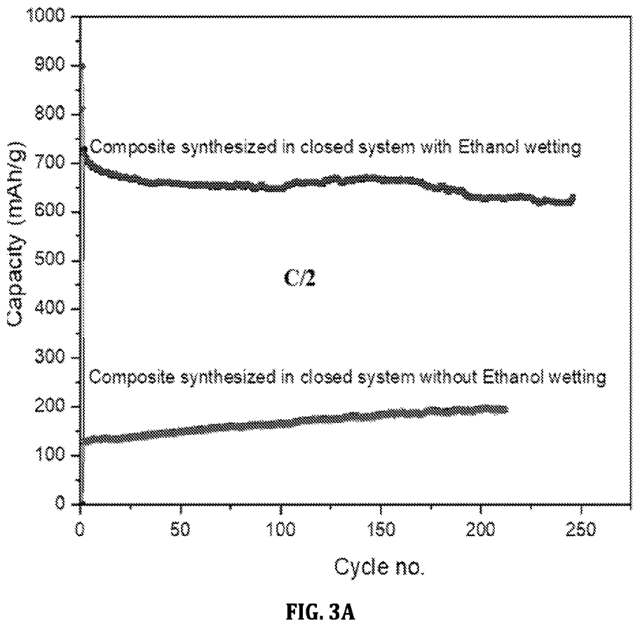

FIG. 3A shows a comparison of the cycle life composites synthesized in the partially closed system by the method of the present invention with and without ethanol wetting at C/2 or 0.5 C rates.

FIG. 3B shows a comparison of the cycle life of composites synthesized in the partially closed system by the method of the present invention with different sulfur loadings at C/2 or 0.5 C rates.

FIG. 3C shows voltage profiles of the composite synthesized in the partially closed system by the method of the present invention with ethanol wetting.

FIG. 3D shows voltage profiles of the composite synthesized by the method of the present invention without ethanol wetting.

FIG. 4 shows the Fourier Transform Infrared (FTIR) absorbance of sulfurized polyacrylonitrile (SPAN) with a high sulfur percentage synthesized in a closed system by the method of the present invention with ethanol wetting FIG. 5A shows cyclic voltammetry of a SPAN-Li half-cell using the SPAN synthesized in the closed system by the method of the present invention with ethanol wetting.

FIG. 5B shows a comparison of the voltage profile of the SPAN cathode synthesized in a closed system by the method of the present invention with ethanol wetting and the SPAN cathode synthesized in an open system by the method of the present invention without ethanol wetting.

FIG. 6A shows the voltage profile of a pouch cell comprising SPAN cathodes synthesized by the method of the present invention with different types of lithium anodes.

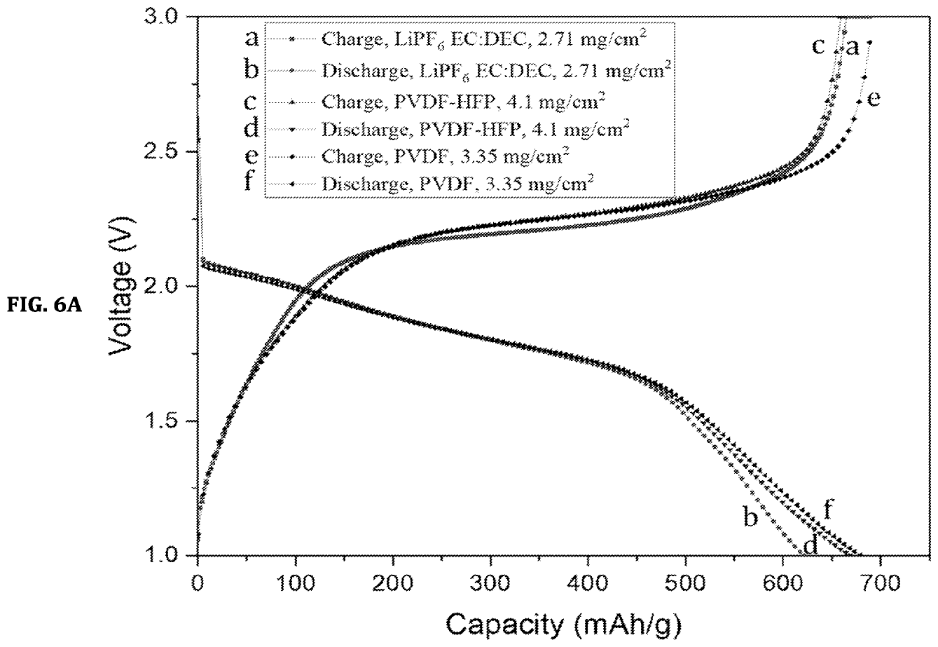

FIG. 6B shows capacity vs cycle life of a pouch cell comprising a SPAN cathode synthesized by the method of the present invention.

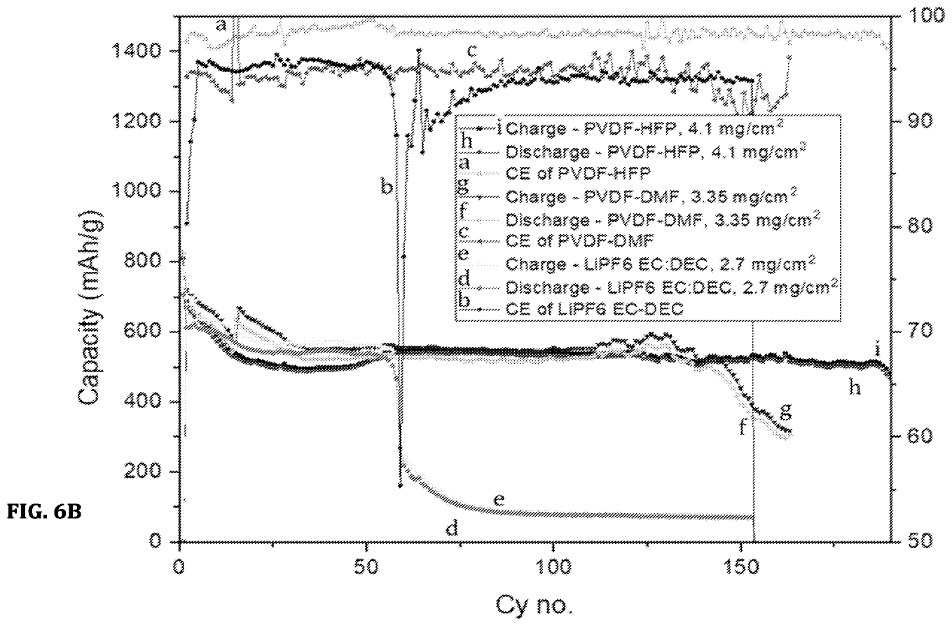

FIG. 7A shows a comparison of cycle life of a pouch cell comprising a lithium metal protected by Gas Diffusion Layer (GDL)-Si-PVDF as anode and the SPAN cathode with 5.41 mg/cm² and 6.05 mg/cm² active material loadings, and GDL-PVDF as anode with SPAN cathode with 5.18 mg/cm² loading. All electrolyte used in all the pouch cells was 1M LiPF₆ in EC-DEC [1:1] with 5% 1,1,2,2-tetrafluoroethyl-2,2,3,3-tetrafluoropropyl ether (TTE).

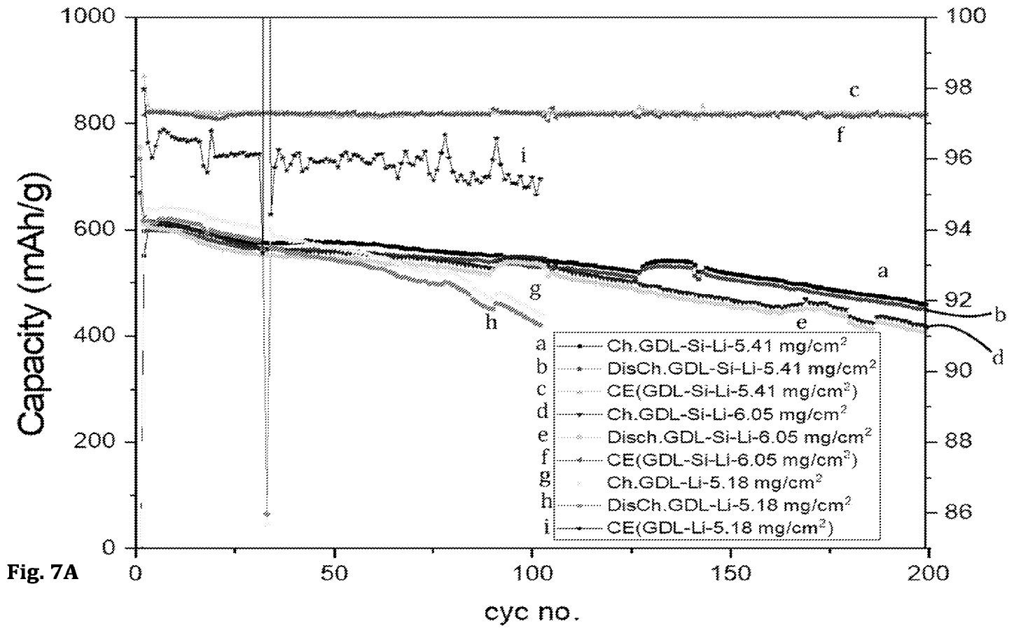

FIG. 7B shows voltage profiles of a pouch cell comprising a lithium metal protected by GDL-Si-PVDF as anode and the SPAN cathode with 5.41 mg/cm² and 6.05 mg/cm² active material loadings, and GDL-PVDF as anode and SPAN cathode with 5.18 mg/cm² loading. All electrolyte used in all the pouch cells was 1M LiPF₆ in EC-DEC [1:1] with 5% TTE.

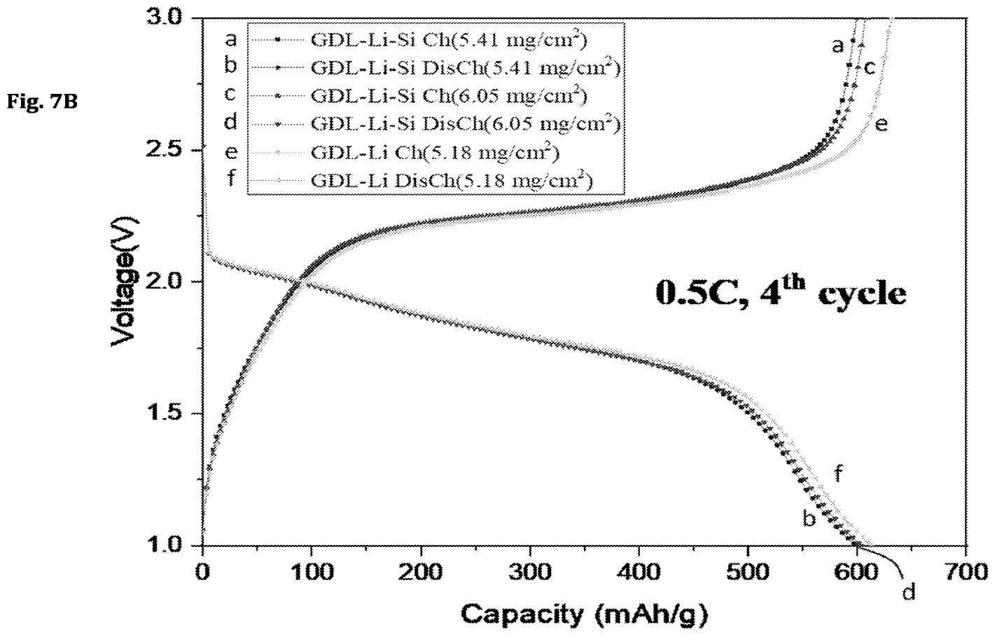

FIG. 7C shows voltage profiles of a pouch cell comprising a lithium metal protected by GDL-Si-PVDF as anode and the SPAN cathode with 5.41 mg/cm² and 6.05 mg/cm² active material loadings, and GDL-PVDF as anode and SPAN cathode with 5.18 mg/cm² loading in the 50^{th} cycle. All electrolyte used in all the pouch cells is 1M LiPF₆ in EC-DEC [1:1] with 5% TTE.

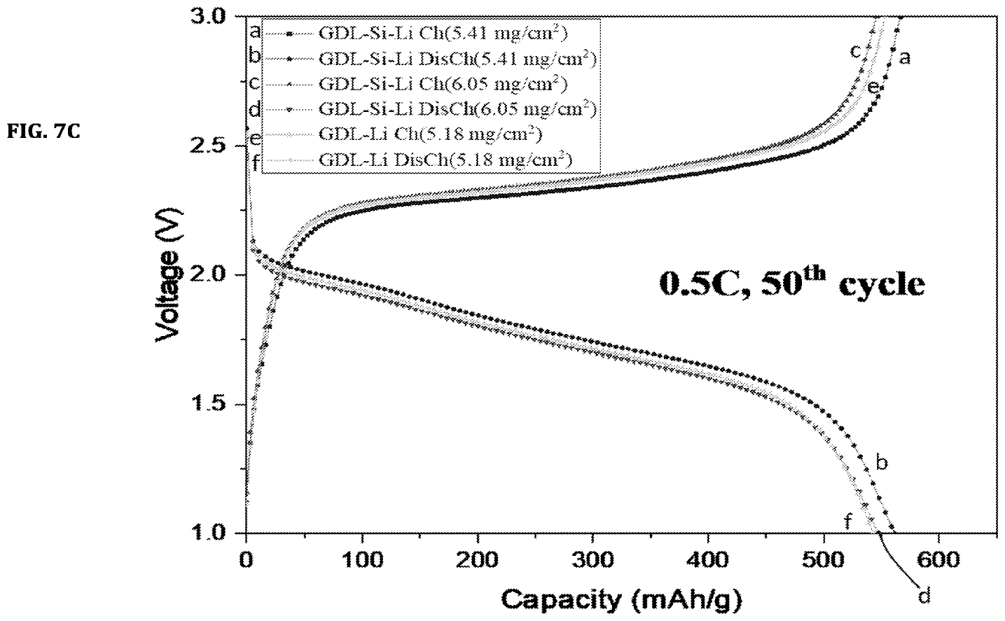

FIG. 7D shows voltage profiles of Pouch cell comprising a lithium metal protected by GDL-Si-PVDF as anode and the SPAN cathode with 5.41 mg/cm² and 6.05 mg/cm² active material loadings, and GDL-PVDF as anode and SPAN cathode with 5.18 mg/cm² loading in the 100^{th} cycle. All electrolyte used in all the pouch cells is 1M LiPF₆ in EC-DEC [1:1] with 5% TTE.

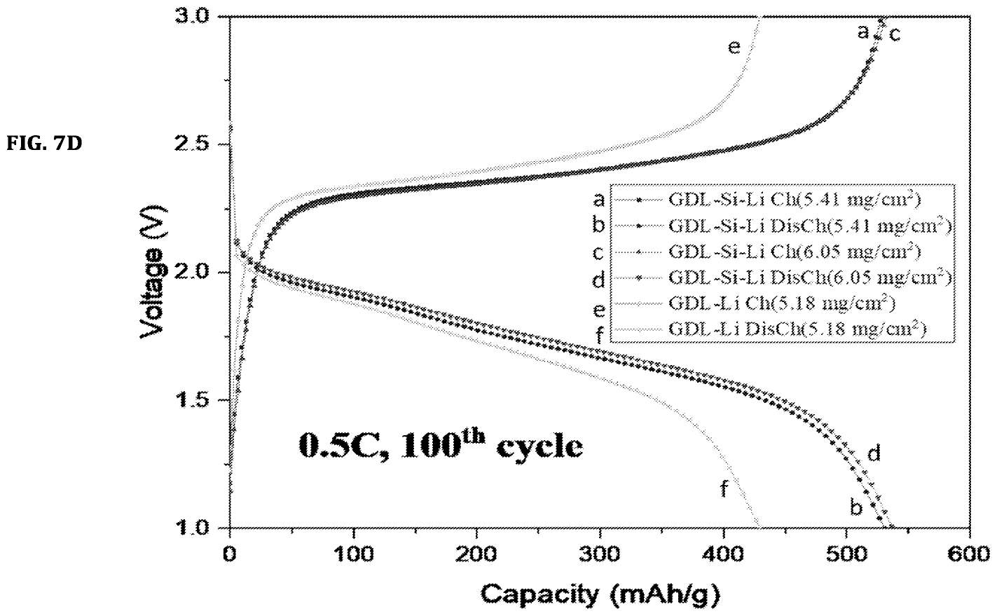

FIG. 8A shows a comparison of Electrochemical Impedance Spectroscopy (EIS) spectra of coin cells comprising lithium protected GDL-PVDF and GDL-Si-PVDF as anode in each and SPAN as cathode at open circuit voltage (OCV).

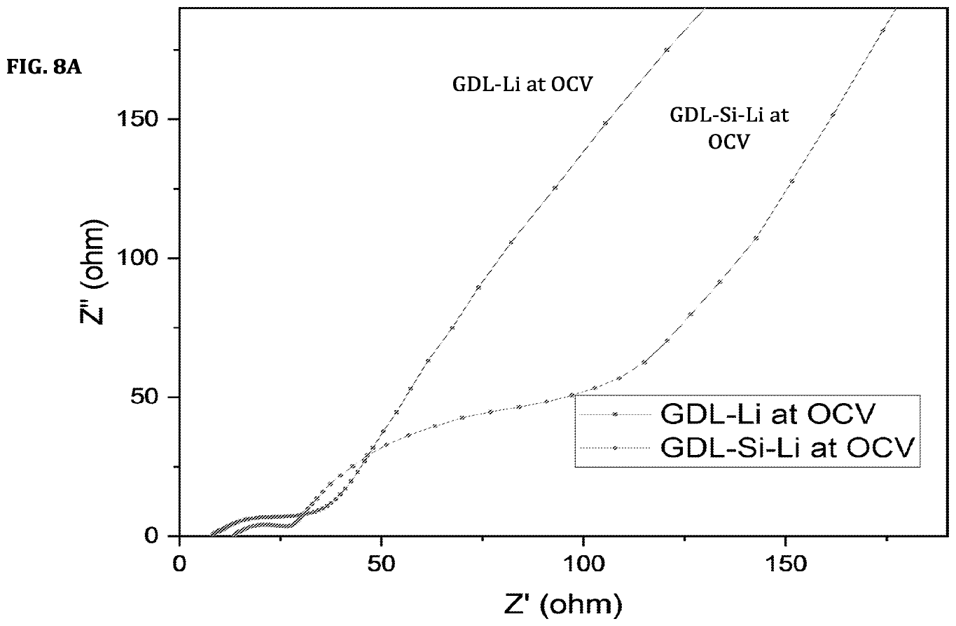

FIG. 8B shows a comparison of EIS spectra of coin cells comprising lithium protected GDL-PVDF and GDL-Si-PVDF as anode in each and SPAN as cathode after 20 cycles.

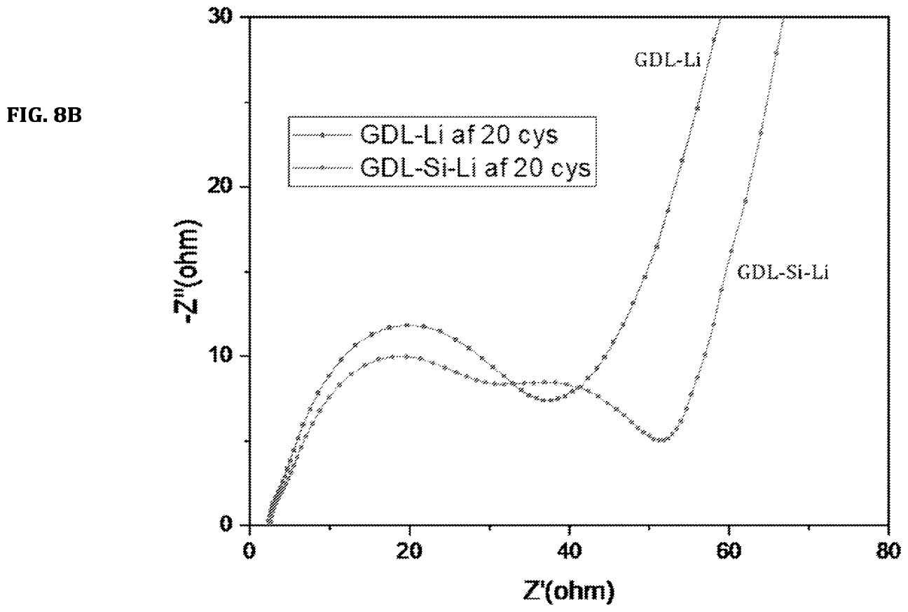

FIG. 8C shows a comparison of EIS spectra of coin cells comprising lithium protected GDL-PVDF and GDL-Si-PVDF as anode in each and SPAN as cathode after 40 cycles.

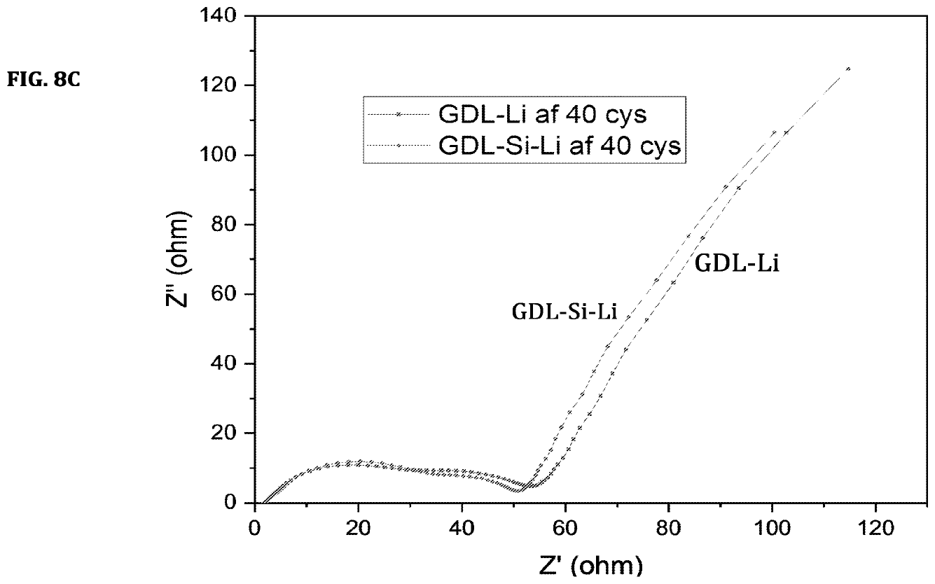

FIG. 8D shows a comparison of EIS spectra of coin cells comprising lithium protected GDL-PVDF and GDL-Si-PVDF as anode in each and SPAN as cathode after 70 cycles.

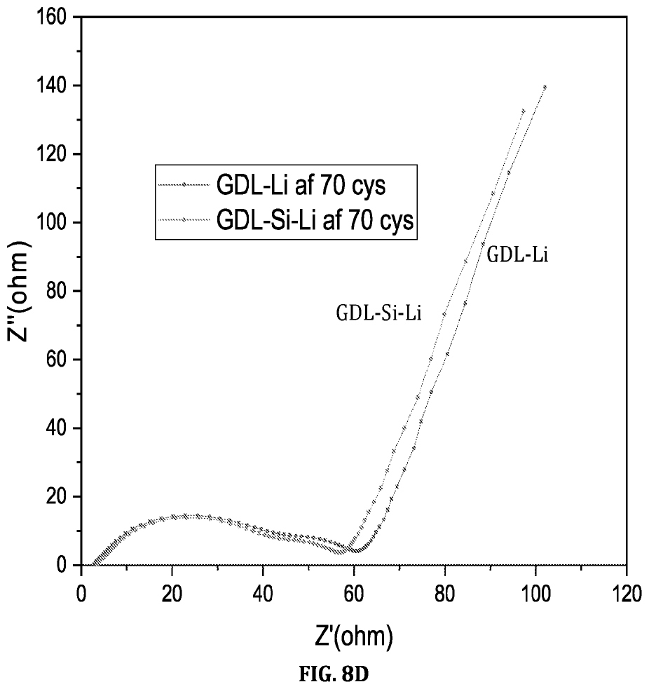

FIG. 8E shows a comparison of EIS spectra of coin cells comprising lithium protected GDL-PVDF and GDL-Si-PVDF as anode in each and SPAN as cathode after 80 cycles.

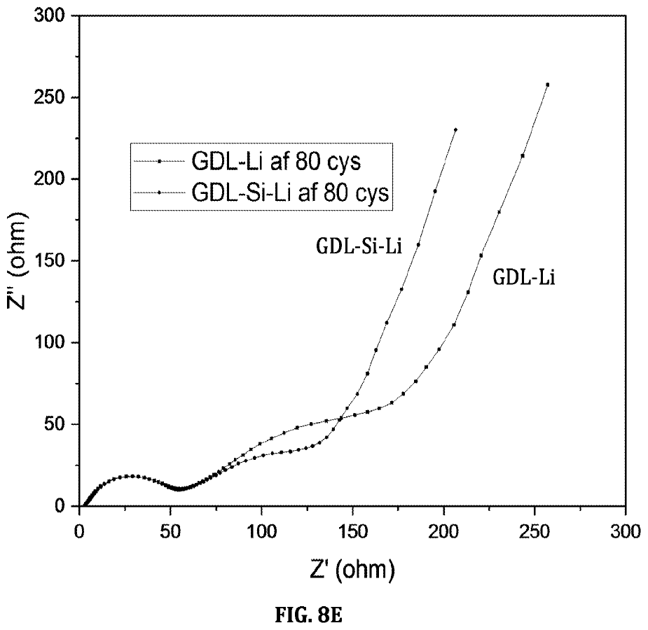

### DETAILED DESCRIPTION OF EMBODIMENTS OF THE INVENTION

The present disclosure relates to methods of making a cathode active material, comprising steps of:
a) mixing a conductive polymer and sulfur in the presence of a solvent to form a mixture, wherein a weight ratio of the amount of the conductive polymer to the amount of sulfur is from about 1:2 to about 1:8;
b) heating the mixture to a temperature of from about 250° C. to about 450° C., or from about 300° C. to about 400° C., or from about 325° C. to about 375° C. under a pressure of from about 0.05 bar to about 2.0 bar, or from about 0.1 bar to about 1.5 bar, or from about 0.2 bar to 1.0 bar, or from about 0.2 bar to about 0.7 bar, or from about 0.3 bar to about 0.6 bar, to form the cathode active material.

Embodiments of the method involve applying pressure to a mixture of sulfur and a conductive polymer composite during a heating step, such as pyrolysis, thereby confining the sulfur within the conductive polymer. Aspects and/or physical characteristics of the resultant product may be modified by controlling the pressure applied during the heating step, in addition to one or more other parameters.

To maintain the desired pressure, it may be necessary to provide an outlet for the reactor that can be adjusted to account for pressure development in the reactor due to the heating of the components. For example, sulfur evolution and vaporization of a solvent such as ethanol present in the reactor will typically increase the pressure in the reactor as the confinement process proceeds.

The method is preferably carried out in a reactor that includes an outlet that can be closed, partially closed or opened to adjust the pressure in the reactor by allowing gas to escape from the reactor. Throughout the heating step, the outlet of the reactor may be maintained in the closed state, i.e. the outlet is closed to allow the pressure in the reactor to increase and/or to maintain the pressure in the reactor in a range of, for example, from about 0.2 bar to 2.0 bar or another desired range, which state of the outlet of the reactor is referred to herein as the “closed system”. Alternatively, the outlet of the reactor may be opened during a portion of the heating step to vent gas from the reactor in order to control the pressure in the reactor within the exemplary range of from about 0.2 bar to 2.0 bar or another desired range, which state of the outlet of the reactor is referred to herein as the “partially closed system.” In another embodiment, the outlet of the reactor is open throughout the heating step to expose the mixture in the reactor to atmospheric pressure, which state of the outlet of the reactor is referred to as the “open system.”

Venting of gas can be used to reduce the pressure, maintain the pressure in the system, slow the pressure increase in the reactor, or any combination thereof. A partially closed system allows for control of the pressure within the reactor. As the temperature of the reactor increases the solvent vapor saturation increases the total pressure in the reactor. Accordingly, the process is preferably carried out in a partially closed system, in order to avoid generation of an unacceptably high pressure level in the reactor.

The conductive polymer may be a nitrogen-containing polymer which may be selected from polyamide, polyaniline, and poly(nitroaniline) and mixtures thereof. Suitable non-nitrogen conductive polymers may be selected from polyacetylene, polypyrrole poly(p-phenylene vinylene), poly(thiophene), poly(3,4-ethylenedioxythiophene)) or combinations thereof. The conductive polymer may be a mixture of nitrogen and non-nitrogen conductive polymers.

The conductive polymer may, in some embodiments, be provided by use of a non-conductive nitrogen-containing polymer in the method of the invention since such a non-conductive nitrogen-containing polymer can be rendered conductive by the pyrolysis step of the present invention.

The conductive polymer may be mixed with sulfur in a weight ratio of 1:2 to 1:8, or from about 1:3 to 1:6, or from about 1:3.5 to about 1:5 by any suitable mixing process, such as, for example, wet ball milling for 5-10 hrs at 400 rpm followed by placing the mixture in a pyrolysis apparatus with a suitable pressure control outlet and pyrolyzed at 300° C. to 350° C. for 2-8 hours in a suitable furnace.

As temperature increases, the sulfur evolution takes place, further increasing the pressure. The pressure can be monitored via a pressure gauge fitted to a tubular furnace flange. The pressure varies as the size of the outlet opening of the apparatus is altered, whereby control of the pressure can be implemented.

Using the method of the present disclosure, cathode active materials with sulfur loadings of 53-60 wt. % within the conductive polymer demonstrated a stable electrochemical performance for more than 200 cycles.

It is possible to confine more sulfur within the conductive polymer to achieve sulfur loadings in excess of 60 wt. %. For such embodiments, steps should be taken to control the sulfur particle size and morphology in order to ensure satisfactory electrochemical performance of the resultant cathode. For example, composite active materials with higher sulfur loadings and/or improved electrochemical properties may be synthesized in the partially closed system with a trace amount of ethanol wetting, or other solvent wetting to control the sulfur particle size and morphology as demonstrated in the working examples herein.

The method of the present invention is carried out in the presence of a solvent. Preferably, the solvent employed in the method does not dissolve sulfur and has a boiling point such that the solvent is vaporized to a vapor state during the heating step. Suitable solvents include ethanol, acetonitrile, acetone, isopropanol, dimethylformamide [DMF], dichloromethane, ethyl acetate, ethylene dichloride, heptane, n-propanol and mixtures thereof. The solvent may be present in any amount greater than 0 wt. %, at the stage of mixing, as any excess solvent may be evaporated during the grinding mixing step, prior to the heating step. Preferably, the solvent is present in the step of mixing in an amount of from 2 wt. % to 8 wt. % or less than 4 wt. %, based on a total weight of the mixture formed in the mixing step of the method. The presence of the solvent helps create pressure by vaporization of the solvent during the heating step to thereby help increase the sulfur loading while helping to reduce the particle size of the sulfur in the synthesized cathode active material.

The important parameters of particle size, morphology and weight percentage of the sulfur for electrochemical performance of the cathode. are controllable by using a wet mixture (with ethanol wetting) in the heating step and that, in comparison to a dry mixture (without ethanol wetting), better control of sulfur particle size and morphology was achieved.

Without being bound by theory, it is thought that the pressure exerted by ethanol vapor formed in the reactor at temperatures above 100° C. enhanced the sulfur adsorption onto the conductive polymer matrix and resulted in a reduced sulfur particle size, thereby improving the performance of the resultant cathode.

It was also found that a combination of a conductive binder with the sulfur confined the conductive polymer provided stable electrochemical performance even at higher sulfur loadings of 65-70 wt. %. From these experiments, it is expected that the capacity of batteries employing the cathode materials fabricated by preferred methods of the present invention will have capacities of up to 800 to 850 mAh/g with respect to the weight of the composite active material.

Additionally, the conductive polymer-sulfur composite may be pyrolyzed with different polymers, other than or in addition to the conductive polymer. Such other polymers may include polymers which become conductive on calcination in order to further improve the conductivity of the composite and enhance its cyclability. Suitable examples of these alternative or additional polymers include, but are not limited to, linear polyene's or polyacetylene producing-precursors like polyvinyl alcohol (PVA), polyvinylidene difluoride (PVDF), and others. Preferably, these polymers are mixed with the sulfur and conductive polymer mixture in the mixing step, at a weight ratio of weight percentage of polymer to the sulfur and nitrogen-containing polymer mixture of from about 1:25 to 1:100 and pyrolyzed in inert atmosphere at a temperature ranging from about 250° C. to about 375° C. During pyrolysis, polyene is obtained from the PVA or PVDF as a result of dehydrogenation or dehydro-fluorination. This polyene will bind strongly to the sulfur and conductive polymer composite to thereby enhance the conductivity of the composite cathode active material. Also, it is believed that the polyene supports the volume change of the sulfur during cycling because of its polymeric nature thus minimizing pulverization of sulfur during cycling.

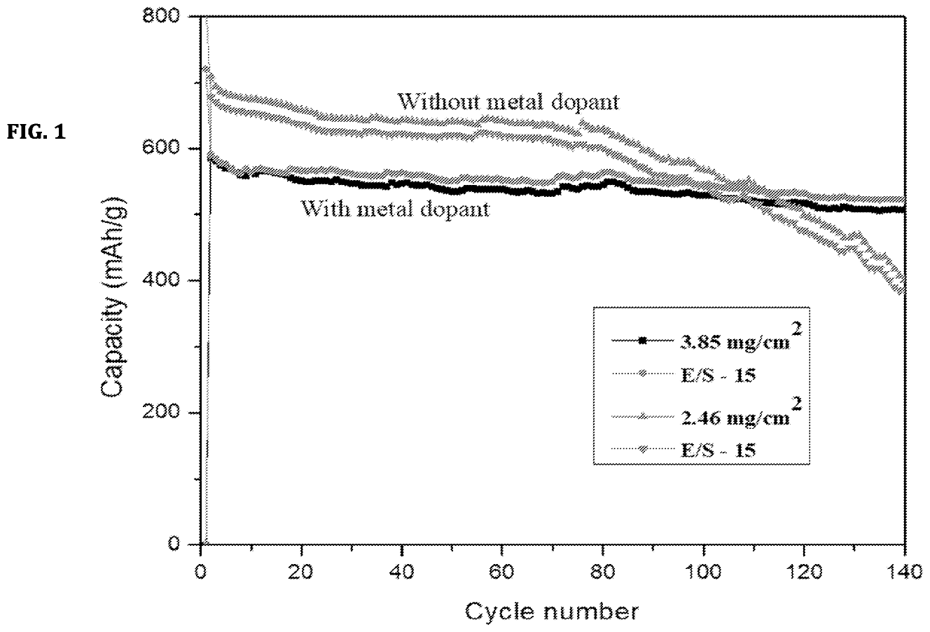

The conductivity of the composite may be further improved by doping with a dopant, for example, magnesium, iron, cobalt, nickel, molybdenum, and iodine, or combinations thereof. An individual metal or a mixture of metals may be used as dopants and these dopants can be introduced prior to the heating step, in the composite in-situ. Preferably, the dopant is present in an amount to provide a weight ratio of dopant to a total weight of all other components used to form the mixture of step a) of from about 1:5 to about 1:10, or from about 1:5 to about 1:8, or from about 1:6 or from about 1:7. Dopants have been found to improve electron transfer across the grain boundaries of the cathode active material and also between the current collector and active material, thereby enhancing the overall conductivity of the cathode. Furthermore, it has been found that the inclusion of a metal dopant reduces the polarization of the cathode active material due to improved conductivity. These advantages enhance the cycle life of the battery, as shown in FIG. 1. Cathode composites made with iodine doped polyene showed a significant improvement in conductivity and attained a stable cycle life of up to 400 cycles.

FIG. 1 shows the cycle life of pouch cells comprising a conductive polymer-sulfur composite with and without metal dopant as the cathode and lithium metal as the anode. FIG. 1 also shows the capacity of the conductive polymer-sulfur composite with and without dopant. Although the initial capacity of the conductive polymer-sulfur composite with metal dopant is lower than without metal dopant at 590 mAh/g, compared to 675 mAh/g, the stable cycling is improved. The conductive polymer-sulfur composite without metal dopant shows a capacity which rapidly fades compared to the conductive polymer-sulfur composite with metal dopant. This result suggests that the addition of metal dopants by in-situ method increases the conductivity of the cathode, and thus, improves the cycle life of the battery.

The use of organic polymers in the method increases the flexibility of the process by increasing the number of active sulfur binding sites, and thus, sulfur loading can be further increased to achieve a higher capacity. It is expected that molecular engineering of the conductive polymer can also be used to tune the properties of the composite, such as, for example, to enhance the redox potential. Thus, different combinations of the components used to make the conductive polymer that confines the sulfur will allow further optimization of the cathode. Thus, substituting or adding electronegative elements onto the molecular structure of the conductive polymer by molecular engineering, can be employed to vary the highest occupied molecular orbital (HOMO) and lowest unoccupied molecular orbital (LUMO) of the conductive polymer to thereby provide a positive potential shift that can be employed to increase the output redox potential thereby increasing the energy density. Electronegative elements as dopants increase the oxidation potential of the conductive polymer and improve the charge and discharge potential. In addition to the above-mentioned dopants, electronegative elements like fluorine, iodine, nitrogen, boron, etc., may be used as substitutions or dopants on the conductive polymer in small weight percentages ranging from 0.1-1 wt. %, based on the total weight of the mixture formed in the mixing step.

Thus, the combination of improved sulfur confinement, use of a conductive binder and molecular engineering of the conductive polymer that confines the sulfur is expected to improve the overall energy density to more than 500 W-h/kg of the battery.

Utilizing this cathode design, pouch cells of 1 Ah to 3 Ah may be fabricated.

In various embodiments, pretreated lithium-metal is used as the negative electrode and additive-containing carbonates are used as electrolyte solvents.

The present disclosure provides a facile synthesis of a chemically linked, confined sulfur and conductive polymer composite with improved sulfur loading of 45-80 wt. % with a gravimetric capacity of 700-850 mAh/g at 0.5 C.

The composite is capable of suppressing polysulfide shuttling due to the sulfur confinement. Composites with different sulfur loadings were successfully synthesized by mixing sulfur with a conductive polymer followed by pyrolysis at 275° C. to 400° C. for 2-6 hrs under an inert atmosphere. With such sulfur loadings, stable capacities of 600-620 mAh/g (53 wt. % sulfur loading), and 700-750 mAh/g (60 wt. % sulfur loading) at 0.5 C were attained in the carbonate electrolyte. The capacity attained by the above-mentioned composite is higher than that of composites that have been reported in the literature for a sulfur cathode in a carbonate electrolyte.

A conductive polymer/sulfur composite has been synthesized in which sulfur is chemically linked and confined within a nitrogen-containing polymer or non-nitrogen-containing conductive polymer such that small sulfur chains are held in the conductive polymer, thus avoiding the formation of soluble polysulfides during cycling. The present method provides the ability to tune the sulfur percentage and particle size (control on tap density) in the composite, which are important parameters for the electrochemical performance. In this method, the composite has been synthesized in a partially closed system (an alumina boat closed with an alumina plate) by mixing the appropriate weight ratio of conductive polymer and sulfur, such as, for example, 1:2 to 1:8, followed by heating from 250-450° C. for 2-8 hours in the inert atmosphere. Prior to synthesis, in the closed system upon reaching the boiling point of ethanol, there is an increase in the vapor pressure of the system provided by ethanol wetting. By further increasing the temperature above 159° C., sulfur starts to break and form di-radicals which are unstable and react with C═C and C═N double bonds. By further increasing the temperature to 250-400° C., the long chain sulfur di-radicals break into smaller chain di-radicals, and simultaneously, the conductive polymer, e.g., the nitrogen-containing polymer, undergoes chemical and structural rearrangement, during which unstable sulfur di-radicals link chemically and are thereby physically confined within the conductive polymer matrix as small chains (e.g. S₂—S₃). During this process, some of the sulfur sublimes and also forms H₂S gas that contributes additional pressure in the reactor.

### Highlights

1. Improving the sulfur loading using pressure exerted by ethanol vapor and sublimed sulfur in a partially closed system.
2. Developing optimum particle sizes and agglomerates (about 500 nm) using the solvent evaporation method.
3. Attaining a high capacity for a sulfur-based cathode in a carbonate electrolyte than other sulfur-based cathodes reported in literature.
4. Attaining a stable cycle life and capacity retention at an average composite loading of 3 mg/cm².
1. Improving the effective sulfur loading from 65-80 wt. % with improved conductivity, so that the capacity of the composite can be optimized to more than 800 mAh/g.
2. Reducing the irreversible capacity so that improved reversible capacity is attained.
3. Attaining a stable and long cycle life at higher cathode active material loadings on electrode, ranging from 10-16 mg/cm².
4. The possibility of increasing the average voltage to 2.1V by doping/substitution of anion/cation onto the conductive polymer, so that the energy density of the system is increased by twofold. The expected energy density with this type of optimization is expected to be 500 W-h/kg of the battery and beyond.

### EXAMPLES

The following examples are illustrative, but not limiting, of the methods and compositions of the present disclosure. Other suitable modifications and adaptations of the variety of conditions and parameters normally encountered in the field, and which are obvious to those skilled in the art, are within the spirit and scope of the disclosure. All patents and publications cited herein are fully incorporated by reference herein in their entirety.

### Example 1

Stoichiometric amounts of the precursor materials (sulfur and nitrogen-containing polymer) were mixed by subjecting them to wet ball milling for 2-8 hours using ethanol as solvent. After ball milling, the mixture was partially dried leaving a trace amount of ethanol for wetting the precursor mixture. The precursor mixture was then transferred to the alumina boat and closed by the alumina plate. The setup was then wrapped in aluminum foil such that there was a partial opening, or a quartz vial closed by Teflon tape with a partial opening. Then, the precursor mixture was pyrolyzed in a tubular furnace (Thermolyne) at a temperature of from 250 to 400° C. for 2-8 hours under an inert atmosphere. Morphology and particle size were analyzed by scanning electron microscopy (SEM).

A cathode electrode slurry was made by mixing cathode active material, conductive carbon black and the water soluble binder sodium carboxy methyl cellulose (NaCMC) or poly acrylic acid (PAA) in a ratio of 80:10:10. The electrode slurry was made by using Flacktek™ speed mixer in which the slurry was mixed at 3000 rpm for 5 minutes and then coated onto a carbon coated aluminum foil using an applicator. An electric coater was used to apply a uniform coating of the slurry. The aluminum foil coated with slurry was dried in a vacuum oven for 12 hours at 60° C. Electrodes were punched into circular discs (11 mm diameter) and coin cells were fabricated in an MBraun™ glove box using a Li-circular disc as the counter and reference electrodes and 1M LiPF₆ in ethylene carbonate:diethylene carbonate (EC:DEC) as electrolyte. These coin cells were tested by cyclic voltammetry using a Biologic potentiostat and cycle life was evaluated using a Neware battery cycler.

The pressure exerted by the ethanol vapor not only provides control of the particle size, distribution of the sulfur, but also enhances the sulfur adsorption onto the nitrogen-containing polymer matrix, thus increasing the active sulfur content of the composite. The ethanol solvent is evaporated on heating thereby being removed from the gap between the precursor mixture particles and the evaporated ethanol solvent increases the pressure of the system thus maintaining the same gap in the composition until the final product is formed with little variation in the particle size and distribution.

When the composite was synthesized in the above-mentioned system without the trace amount ethanol/ethanol wetting, then bulk and agglomerated particles having sizes ranging from 900 nm to 1.2 micrometers were formed. Such large particles are not suitable for providing optimal electrochemical performance because the insulating nature of the sulfur dominates in these bulk particles with low conductive support thus reducing the conductivity of the cathode active material.

### Results and Discussion

Improved Sulfur Loading Due to Pressure Exerted by the Sublimed Sulfur and Ethanol Vapor 1 gm of nitrogen-containing polymer heated from 200-400° C. for 2-8 hours gave a yield of 680 mg product. The yields of the composite synthesized in the partially closed system with ethanol wetting and in open system without ethanol wetting were as follows
1. A yield 3.8 gms of composite from a mixture containing 2 gms of nitrogen-containing polymer and 8 gms of sulfur was obtained. The sulfur loading was calculated to be 64 wt. %.
2. A yield of 3.2 gms of composite was obtained from a mixture containing 2 gms of polymer and 8 gms of sulfur. The sulfur loading was 57.5 wt. % (without ethanol vapor).

In the above, about 20 percent of the sulfur was lost/utilized in the first formation cycle that may form CEI (cathode electrolyte interphase) on the cathode, and the remainder of the sulfur was utilized to provide the reversible electrode capacity. Thus, for 3.8 gms of composite, the active sulfur was 44 wt. % and for 3.2 gms of composite the active sulfur was 37.5 wt. %. These results suggest that the pressure exerted by the ethanol vapor, sublimed sulfur and H₂S gas increased the sulfur loading in the composite.

Comparison of Particle Size and Morphology Between Composites Synthesized in a Partially Closed System with and without Ethanol

### SEM

The vapor pressure exerted by ethanol vapor affected the particle size and morphology of the sulfur. Composite synthesized in the partially closed system with ethanol wetting showed many individual particles (primary particles) having sizes ranging from 100-250 nm. These particles formed agglomerates (secondary particles) with sizes ranging from 400-500 nm.

In comparison, composite synthesized in the partially closed system without ethanol wetting also had particle sizes ranging from 100-250 nm, but the agglomerates formed from these particles were found to have sizes ranging from 900 nm to 1.5 micrometers, may negatively impact the electrochemical performance of the cathode active material. These large agglomerates increased the charge transfer resistance and the overall resistance due to close contact of the insulating sulfur particles. Dynamic Light Scattering (DLS) analysis was conducted to confirm the average size distribution of the agglomerates, DLS reports showed that the average sulfur agglomerate size of the composite synthesized in the partially closed system with ethanol wetting was about 500 nm and without ethanol wetting was about 900 nm.

### Electrochemical Performance

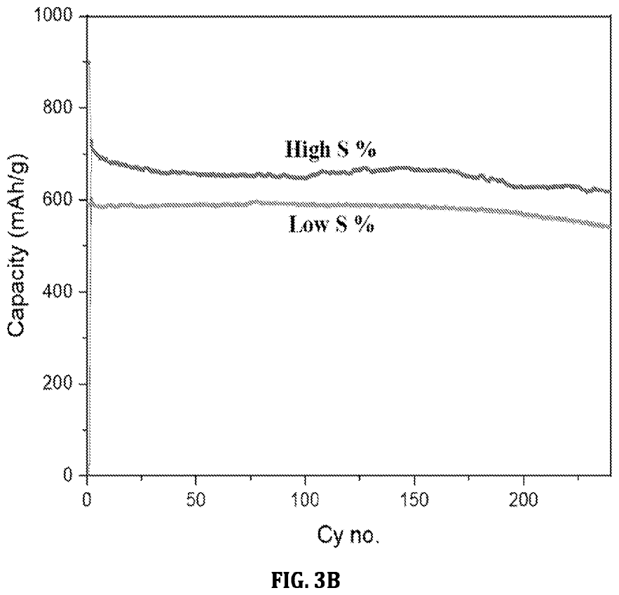

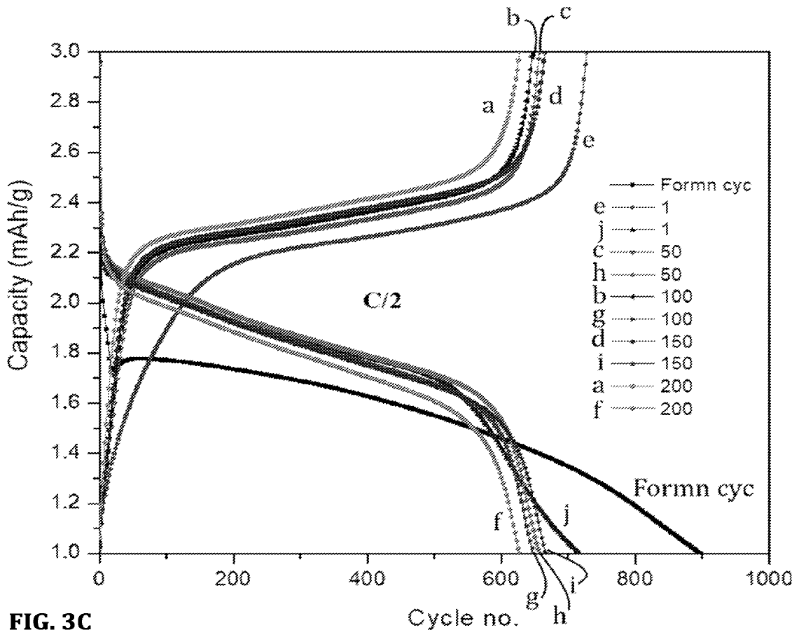

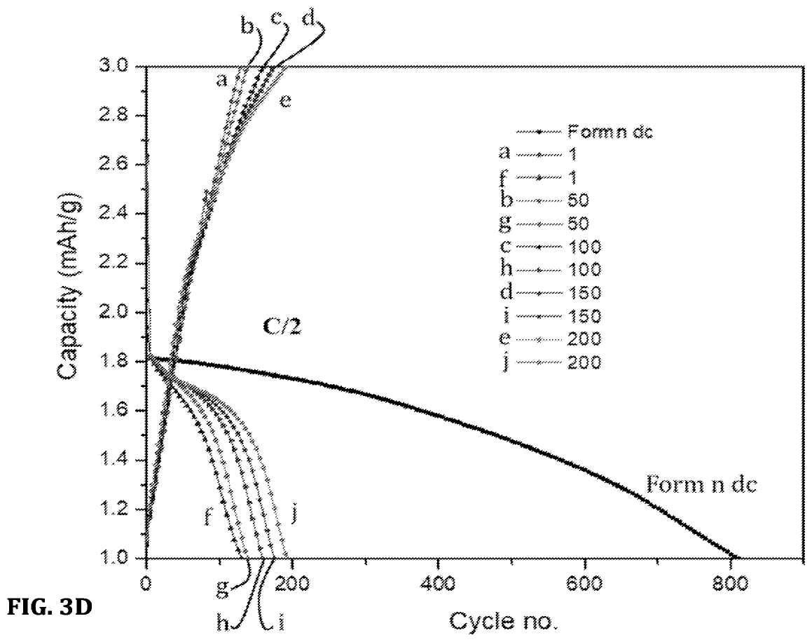

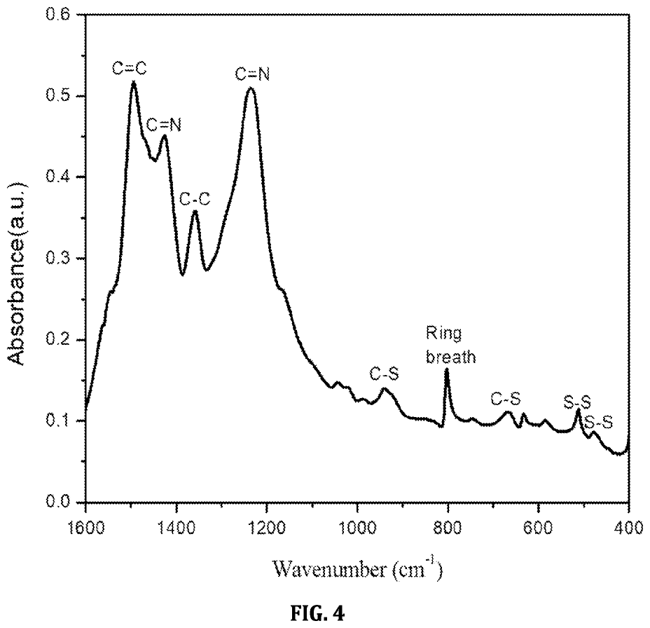

FIG. 3A illustrates the capacity vs. cycle number of the composites synthesized in the partially closed system with and without ethanol wetting. Composites made with ethanol wetting showed initial capacities of 721 mAh/g and 630 mAh/g (240^{th} cycle) at a C/2 rate, whereas the composite made without ethanol wetting exhibited a poorer initial capacity of 131 mAh/g, which increased to 192 mAh/g at the 210^{th} cycle. A conventionally synthesized composite showed an initial capacity of 625 mAh/g at C/2 with a capacity retention of 84% and a composite synthesized in the partially closed system with ethanol wetting showed an improved initial capacity of 723 mAh/g with a capacity retention of 91%, as shown in FIG. 3b.

FIGS. 3C and 3D illustrate voltage profiles of composites synthesized with and without ethanol wetting. Composites made with ethanol wetting had an initial formation discharge cycle with a capacity of 900 mAh/g followed by a reversible discharge capacity of 721 mAh/g. There was an irreversible capacity of 180 mAh/g between the formation cycle and the subsequent discharge cycle having an initial coulombic efficiency of 80 percent. The initial capacity loss is attributed to cathode electrolyte interphase formation on the cathode due to reaction of the electrolyte with surface sulfur. There was a flat discharge plateau starting from 2.2 V up to 1.6 V in which range 90% of the capacity that contributes to the improved energy density was attained. FIG. 3D illustrates the voltage profile of the composite synthesized in the partially closed system without ethanol wetting. The initial formation cycle capacity was 810 mAh/g followed by a drastic decrease in the subsequent cycles showing the poor electrochemical performance of this composite which had an initial columbic efficiency of 16%. The resulting charge and discharge profiles are not flat and look similar to capacitive behavior (i.e., linear). The poor electrochemistry is attributed to the large agglomerate size causing an increase in the resistance for ion and electron transfer contributing to the capacitive behavior. Though there was a reasonable initial formation discharge capacity, due to the bulk size (900 nm or larger) of agglomerates, the attained reversible capacity contribution was only from the surface of the agglomerates, hence resulting in the poor electrochemical performance. The other possible reason for the poor performance is an irreversible volume change during initial formation discharge where most of the active material pulverized and lost electrical contact. This phenomenon is common in active electrodes with bulk particle sizes.

The composite synthesized in the partially closed system with ethanol wetting outperformed the other composites with respect to cycle life and capacity retention. These improvements in electrochemical performance are attributed to the moderate/optimum particle and agglomerate size resulting in low resistance for the transfer of ions and electrons from the surface to the bulk. Moreover, insulating sulfur accumulation is less compared to larger agglomerates thus reducing the overall impedance. Also, due to the moderate size of the agglomerates, there is volume change accommodation without pulverization resulting in a compact electrode without a corresponding loss in electrical contact.

### Example 2

The following materials were used to prepare the SPAN—polyacrylonitrile (M_{w}=150,000 g mol⁻¹, purchased from Sigma Aldrich) and sulfur (99.5%, sublimed, catalog no. AC201250025), ethanol (Sigma Aldrich, 99%).

Materials for SPAN electrode making—carbon black—Super P™ (Alfa aesar), Sodium carboxy methyl cellulose (Alfa Aesar), and styrene butadiene rubber (MTI corporation) Materials for stabilizing the Li-metal—polyvinylidene fluoride (Aldrich chemistry), polyvinylidene fluoride—hexafluoro propylene (Aldrich chemistry), Dimethyl formamide (Fisher chemicals), and Acetone.

Materials for electrochemistry—1M lithium hexafluoro phosphate in ethylene carbonate (EC) and diethyl carbonate (DEC) [1:1] (LiPF6 in EC:DEC—Aldrich), fluoro-ethylene carbonate (FEC) (Alfa Aesar).

### SPAN Synthesis

SPAN was synthesized by mixing the polyacrylonitrile (PAN) and sulfur at 1:4 wt. % by wet ball milled for 12 hours at 400 rpm using the ethanol as the solvent. The mixture was then dried at 50° C. in vacuum oven for 6 hours and subsequently heat treated in a tubular furnace [Nabertherm] at 350° C. for 4 hours under nitrogen flow to obtain the SPAN [sulfurized carbon]. For open synthesis, the PAN/S mixture were kept in an open ceramic boat, while for closed synthesis PAN/S mixture was placed in the alumina ceramic boat closed by an alumina plate followed by wrapping with aluminum foil. For doped SPAN, 2 wt. % of cobalt chloride (Acros oganics) was added to the PAN/S mixture followed by wet ball milling. The cobalt doped samples were also synthesized in the closed and open systems.

Lithium Treatment—Making of 4 wt/Vol % PVDF-DMF Solution and 4 wt/Vol % PVDF-HFP-Acetone Solution and Artificial SEI on Li-Metal—

400 mg of PVDF was dissolved in 10 ml of the DMF and stirred for 12 hours to provide a homogenous solution having a 4 wt/vol % of PVDF-DMF. Similarly, 400 mg of PVDF-HFP was dissolved in 10 ml of acetone and stirred for 12 hours to provide a homogenous solution having a 4 wt/vol % of PVDF-HFP. For the PVDF-HFP treatment, first a PVDF-HFP film was made by coating the PVDF-HFP solution on a glass plate using doctor blade. The coating dried in 5 minutes leaving behind a film that was easily peeled off. The thickness of the film obtained was in the range of 8-10 micrometers. The peeled off solid film was placed on the lithium metal surface followed by roll pressing at 0.328 rpm. Then, a polypropylene separator soaked with DMF solvent was placed on the PVDF-HFP coated lithium metal followed by roll pressing. This process resulted in partial re-dissolution of the solid PVDF-HFP polymer in DMF on Li and facilitated an improved interaction between Li and PVDF-HFP. The excess DMF evaporated in a few minutes and reformed a solid film between the Li and the separator. This process is referred to as the solid-liquid-solid process. For the PVDF film, a wet polypropylene separator was soaked in a 4 wt. % PVDF-DMF solution and placed on the lithium metal surface followed by roll pressing at 0.328 rpm resulting in solid LiF and a completely de-fluorinated polymer coating. This process is referred to as the liquid-solid conversion process.

### Material Characterizations—SEM/EDS. FTIR, XPS, Elemental Analysis, DLS.

The morphological analysis of the materials was conducted using an SEM (Zeiss Supra 50VP, Germany) with an in-lens detector, and a 30-mm aperture was used to examine the morphology and to obtain micrographs of the samples. To analyze the surface elemental composition, Energy Dispersive Spectroscopy (EDS) (Oxford Instruments) in secondary electron-detection mode was used. The surface of the composites was analyzed with X-ray photoelectron spectroscopy (XPS). To collect XPS spectra, Al-Ka X-rays, with spot sizes of 200 mm and a pass energy of 23.5 eV were used to irradiate the sample surface. The Al-Ka X-rays use an aluminum element as its source and the X-rays are produced due to the transition of electrons between the core energy levels, i.e. the fall of electrons from the L-shell to the K-shell. A step size of 0.05 eV was used to gather the high-resolution spectra. CasaXPS™ (version 23.19PR1.0) software was used for spectra analyses. The XPS spectra were calibrated by setting the valence edge to zero, which was calculated by fitting the valence edge with a step-down function and setting the intersection to 0 eV. The background was determined using the Shirley algorithm, which is a built-in function in the CasaXPS™ software. The infrared spectra of the samples were collected using a Fourier transform infrared (FTIR) spectrometer (Nicolet iS50, Thermo-Fisher Scientific) using an extended range diamond Attenuated Total Reflection (ATR) accessory. A deuterated triglycine sulfate (DTGS) with a resolution of 64 scans per spectrum at 8 cm⁻¹ was used and all the spectra were further corrected with background, baseline correction and advanced ATR correction in the Thermo Scientific Omnic™ software package.

### Electrode Formation

Initially 80 wt. % of SPAN and 10 wt. % carbon black super P™ were mixed in a Flacktek™ speed mixer for 5 minutes. Homogenous 4 volume percent sodium carboxymethylcellulose-styrene-butadiene rubber (NaCMC-SBR) binder was made in another vial using water as the solvent in the Flacktek™ speed mixer. Then, the SPAN-carbon black mixture was added to the binder solution in an amount to make up 10 wt. % of the complete electrode slurry and speed mixed for 1 hour at 2500 rpm with a 5 minute gap between each cycle. The resultant electrode slurry was coated onto the carbon coated aluminum foil using an applicator with a thickness of 250 micrometer followed by drying in oven at 50° C.

### Coin-Cell Fabrication

The dried electrodes were cut using a hole punch (f=0.5 inch [12.7 mm]) to form disk-sized electrodes. The electrodes were then weighed and transferred to an argon-filled glove box (MBraun LABstar, O₂<1 ppm and H₂O<1 ppm). The CR2032 (MTI and Xiamen TMAX Battery Equipments, China) coin-type Li—S cells were assembled using SPAN (f=12 mm), lithium disk anodes (Xiamen TMAX Battery Equipment's; f=15.6 mm, 450 mm thick), a tri-layer separator (Celgard 2325; f=19 mm), one stainless-steel spring, and two spacers, along with an electrolyte. The electrolyte with 1M LiPF₆ in EC:DEC at a 1:1 volume ratio was purchased from Aldrich chemistry, with H₂O<6 ppm and 02<1 ppm. The assembled coin cells were rested at their open-circuit potential for 12 hours to equilibrate them before performing electrochemical experiments at room temperature. Cyclic voltammetry was performed at various scan rates (0.5 mV/s) between voltages of 1 V and 3 V with respect to Li/Li+ with a potentiostat (Biologic VMP3). Prolonged cycling stability tests were carried out with a Neware BTS 4000 battery cycler at different C-rates (where 1 C=650 mAhg⁻¹) between voltages of 1.0 V and 3.0 V.

### Pouch Cell Fabrication

Cathodes were punched with dimensions of 57 mm×44 mm using a die cutter MSK-T-11 (MTI, USA). A 4-inch (101.6 mm) length lithium strip (750 μm thick, Alfa Aesar) was rolled by placing it between aluminum-laminated film to provide a 60 mm×50 mm Li sheet using an electric hot-rolling press (TMAX-JS) at 0.328 rpm inside the glove box (MBraun, LABstar Pro). Once the final dimensions of the lithium sheet were achieved (400 μm-500 μm thick-by adjusting the distance between the rollers of the roll press), it was re-rolled with a copper current collector (10 mm) to achieve good adhesion. Finally, the lithium-rolled copper sheet was punched with a 58-mm×45-mm die cutter (MST-T-11) inside the glove box. The cathode and anode were welded with aluminum and nickel tabs (3 mm), respectively. The tabs were welded with an 800-W ultrasonic metal welder, using a 40 KHz frequency; a delay time of 0.2 seconds, welding times of 0.15 second and 0.45 section for Al|Al and Cu|Ni, respectively; and a cooling time of 0.2 second with a 70% amplitude. The anode and cathode were placed between a Celgard 2325 separator, and the pouch was sealed with 3-in-1 heat pouch sealer inside the glove box with a 95 kPa vacuum, 4 second sealing time at 180 C and a 6-second degas time.

Table 1 shows the elemental analysis in weight percentages of the elements of the carbonized PAN, SPAN synthesized in a closed system (w/Co doping), and SPAN synthesized in an open system, wherein the closed system synthesis was carried out with ethanol wetting and the open system synthesis was carried out without ethanol wetting.

TABLE 1

| Wt. % | % N | % C | % S |
|---|---|---|---|
| PAN | 22.24 | 62.73 | 0 |
| SPAN [Open] | 14.66 | 33.80 | 45.30 |
| SPAN [closed system w/Cobalt doped] | 13.28 | 31.91 | 53.62 |

Elemental analysis shows that the percentage of sulfur was zero in the PAN which is carbonized at 350° C. under the flow of nitrogen. In contrast, the percentage of the sulfur was 53.62% in the SPAN synthesized in the closed system, which is higher than the sulfur percentage of the SPAN synthesized in the open system (45.30%).

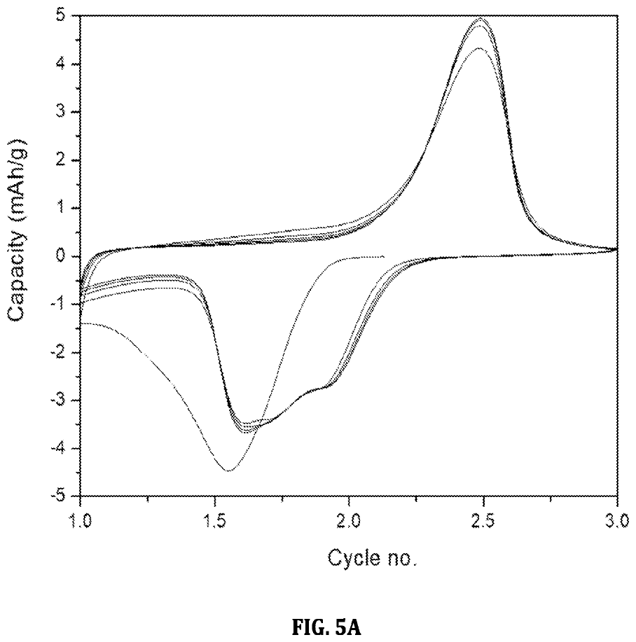

In FIG. 4, the peaks at 477 cm⁻¹ and 511 cm⁻¹ correspond to S—S stretching¹ and the peaks at 668 cm⁻¹ and 936 cm⁻¹ are assigned to C—S stretching.^{2,3} The peak at 803 cm⁻¹ indicates the formation of a hexahydric ring.¹² The peaks at 1495 cm⁻¹ and 1359 cm⁻¹ are assigned to the C═C¹³ and C—C deformation, and the peaks at 1427 cm⁻¹ and 1235 cm⁻¹ correspond to C═N stretch.¹⁴ In brief, the signals of C—C, C═C, and C═N confirm to the comprehensive sulfur-assisted dehydrogenation, cyclization, and aromatization of the aliphatic PAN to a polyaromatic system.

The vapor pressure exerted by ethanol vapor affects the particle size and morphology. Composites synthesized in the closed system with ethanol wetting show many individual particles having sizes ranging from 100 nm-250 nm, as measured by a scanning electron microscope (SEM) and Dynamic Light Scattering (DLS). These particles form agglomerates (secondary particles) with sizes ranging from 400 nm-500 nm, as measured by a scanning electron microscope (SEM) and Dynamic Light Scattering. The composite synthesized in the closed system without ethanol wetting also had sulfur particle sizes ranging from 100 nm-250 nm, but the agglomerates (secondary particles} formed from the primary particles had sizes ranging from 900 nm to 1.5 micrometers which sizes are not desirable for good electrochemical performance of a cathode active material. Large agglomerates increase the charge transfer resistance and increase the overall resistance due to close contact of the insulating sulfur particles. DLS analysis was done to further confirm the average size distribution of the agglomerates. The DLS reports indicate that the average agglomerate size of the composite synthesized in the closed system with ethanol wetting was about 500 nm and without ethanol wetting was about 900 nm.

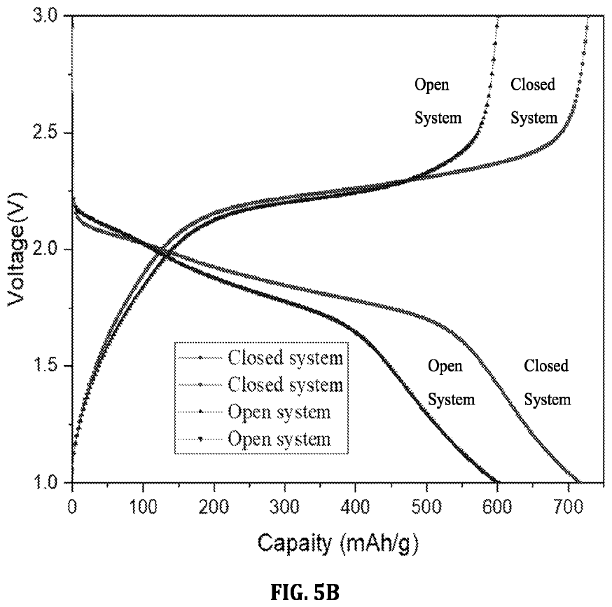

The electrochemical behavior of the SPAN cathode | LiPF6 electrolyte | Li-anode cell was characterized by using cyclic voltammetry (shown in FIG. 5A). Cyclic voltammetry (CV) was tested within the voltage range of 1 V and 3 V at 0.2 mV/s. The initial cathodic peak at 1.55 V is ascribed to the solid electrolyte interphase formation on the cathode surface and activation of the bonded sulfur chains. During initial discharge there was cleavage of S—S bonds adjacent to carbon rings that required more energy input. The peaks at voltages below 2.1V correspond to S—S bond breakage¹⁵ FIG. 5B shows the capacity vs cycle number of the composites synthesized in the closed system with and without ethanol wetting. Composite with ethanol wetting showed initial and final capacities of 721 mAh/g and 630 mAh/g [240^{th} cycle] at a C/2 rate, whereas the composite without ethanol wetting exhibited a poor initial capacity of 131 mAh/g that increased to 192 mAh/g at the 210^{th} cycle. The composite synthesized conventionally showed an initial capacity of 625 mAh/g at C/2 with a capacity retention of 84% and the composite synthesized in the closed system with ethanol wetting showed an improved initial capacity of 723 mAh/g with a capacity retention of 91% (see FIG. 3A).

FIGS. 3C and 3D show the voltage profiles of composites synthesized with and without ethanol wetting. The composite synthesized with ethanol wetting showed an initial formation discharge cycle with a capacity of 900 mAh/g followed by a reversible discharge capacity of 721 mAh/g. There was an irreversible capacity of 180 mAh/g between the formation cycle and consequent discharge cycle having an initial coulombic efficiency of 80 percent. The initial capacity loss was attributed to cathode electrolyte interphase formation on the cathode due to reaction of the electrolyte with the surface sulfur. This was confirmed by cyclic voltammetry.¹⁶ FIG. 3C shows that the voltage plateau during the initial discharge cycle (˜1.8 V) was lower than the values observed in subsequent cycles. There was a flat discharge plateau starting from 2.2 V up to 1.6 V in which range 90% of the capacity that contributes to the improved energy density was attained.

FIG. 3D shows the voltage profile of SPAN synthesized in the closed system without ethanol wetting. FIG. 3D shows an initial formation cycle capacity of 810 mAh/g followed by a drastic decrease in subsequent cycles showing the poor electrochemistry with an initial columbic efficiency of 16%. The charge and discharge profiles are not flat and look similar to capacitive behavior i.e., a straight line. The poor electrochemistry may be attributed to the large sulfur agglomerate size which increases the resistance for ion and electron transfer contributing to capacitive behavior. There is good initial formation discharge capacity, but due to the bulk size (900 nm) of the agglomerates, the attained reversible capacity contribution is only from the surface of the agglomerates, thus resulting in the poor electrochemical performance. Another possible reason may be the irreversible volume change during initial formation discharge where most of the active material pulverizes and loses the electrical contact. This phenomenon is common in an active electrode with bulk size.

The composite synthesized in the closed system with ethanol wetting outperformed the other composites in cycle life and capacity retention. The improvement in the electrochemical performance is attributed to the moderate/optimum particle and agglomerate sizes resulting in low resistance for the transfer of ions and electrons from the surface to the bulk. Moreover, the insulating sulfur accumulation was less compared to larger agglomerates thus reducing the overall impedance. Due to its moderate size, there will be volume change accommodation without pulverization resulting in a compact electrode without a loss of electrical contact.

FIG. 5B shows a comparison of the voltage profile of the SPAN cathode synthesized in the closed system with ethanol wetting and in the open system without ethanol wetting. Both cathodes show similar voltage profiles irrespective of sulfur percentage. SPAN synthesized in the open system without ethanol wetting showed an initial discharge capacity (formation cycle) of 769 mAh/g and the discharge capacities of other subsequent cycles ranged from 620 mAh/g (2^{nd} cycle)-550 mAh/g (90^{th} cycle) which are lower than SPAN synthesized in the closed system with ethanol wetting. This suggests that there is an increase in the sulfur percentage of SPAN synthesized in the closed system with ethanol wetting since SPAN synthesized in the open system with and without ethanol wetting showed less capacity which is attributed to low sulfur percentage. A closed system helps in the accumulation of extra sulfur in the composite due to the pressure developed by the ethanol vapor and H₂S gas generated during the synthesis. Also, there is an increase in sulfur percentage in the closed system without ethanol wetting due to pressure developed by sulfide gas generated during synthesis. The absence of ethanol leads to agglomeration of the particles as evidenced by SEM.

Other embodiments of the present disclosure will be apparent to those skilled in the art from consideration of the specification and practice of the embodiments disclosed herein. As used throughout the specification and claims, “a” and/or “an” and/or “the” may refer to one or more than one. Unless otherwise indicated, all numbers expressing quantities, proportions, percentages, or other numerical values are to be understood as being modified in all instances by the term “about.” Accordingly, unless indicated to the contrary, the numerical parameters set forth in the specification and claims are approximations that can vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

It is to be understood that each component, compound, substituent or parameter disclosed herein is to be interpreted as being disclosed for use alone or in combination with one or more of each and every other component, compound, substituent or parameter disclosed herein.

It is further understood that each range disclosed herein is to be interpreted as a disclosure of each specific value within the disclosed range that has the same number of significant digits. Thus, for example, a range from 1-4 is to be interpreted as an express disclosure of the values 1, 2, 3 and 4 as well as any range of such values.

It is further understood that each lower limit of each range disclosed herein is to be interpreted as disclosed in combination with each upper limit of each range and each specific value within each range disclosed herein for the same component, compounds, substituent or parameter. Thus, this disclosure to be interpreted as a disclosure of all ranges derived by combining each lower limit of each range with each upper limit of each range or with each specific value within each range, or by combining each upper limit of each range with each specific value within each range. That is, it is also further understood that any range between the endpoint values within the broad range is also discussed herein. Thus, a range from 1 to 4 also means a range from 1 to 3, 1 to 2, 2 to 4, 2 to 3, and so forth.

Furthermore, specific amounts/values of a component, compound, substituent or parameter disclosed in the description or an example is to be interpreted as a disclosure of either a lower or an upper limit of a range and thus can be combined with any other lower or upper limit of a range or specific amount/value for the same component, compound, substituent or parameter disclosed elsewhere in the application to form a range for that component, compound, substituent or parameter.

### REFERENCES

1. Li, G. R.; Wang, S.; Zhang, Y. N.; Li, M.; Chen, Z. W.; Lu, J. Revisiting the role of polysulfides in lithium-sulfur batteries. Adv. Mater. 2018, 30 (22), 1705590.
2. Lei, D.; Shi, K.; Ye, H.; Wan, Z.; Wang, Y.; Shen, L.; Li, B.; Yang, Q. H.; Kang, F.; He, Y.-B. Progress and perspective of solid-state lithium-sulfur batteries. Adv. Funct. Mater. 2018, 28 (38), 1707570.
3. Qie, L.; Manthiram, A. High-energy-density lithium-sulfur batteries based on blade-cast pure sulfur electrodes. ACS Energy Lett. 2016, 1 (1), 46-51.
4. Peled, E.; Shekhtman, I.; Mukra, T.; Goor, M.; Belenkaya, I.; Golodnitsky, D. Improving the durability and minimizing the polysulfide shuttle in the Li/S battery. J. Electrochem. Soc. 2018, 165 (1), A6051-A6057.
5. Lei, T. Y.; Chen, W.; Lv, W. Q.; Huang, J. W.; Zhu, J.; Chu, J. W.; Yan, C. Y.; Wu, C. Y.; Yan, Y. C.; He, W. D.; Xiong, J.; Li, Y. R.; Yan, C. L.; Goodenough, J. B.; Duan, X. F. Inhibiting polysulfide shuttling with a graphene composite separator for highly robust lithium-sulfur batteries. Joule 2018, 2 (10), 2091-2104.
6. Xiaosong Xiong, Wenqi Yan, Chaolin You, Yusong Zhu, Yuhui Chen, Lijun Fu, Yi Zhang, Nengfei Yu* and Yuping Wu, Methods to Improve Lithium Metal Anode for Li—S Batteries, Frontiers in Chem. 2019 (7), 827.
7. R. Xu, J. Lu, K. Amine, Progress in Mechanistic Understanding and Characterization Techniques of Li—S Batteries, Adv. Energy Mater. 2015, 5, 1500408.
8. Zhang, S. S. Improved Cyclability of Liquid Electrolyte Lithium/Sulfur Batteries by Optimizing Electrolyte/Sulfur Ratio. Energies 2012, 5, 5190-5197.
9. Xianguo Yu, Jingying Xie, Ying Li, Haijiang Huang, Chunyan Lai, Ke Wang, Stable-cycle and high-capacity conductive sulfur-containing cathode materials for rechargeable lithium batteries, Journal of Power Sources 146 (2005) 335-339.
10. X. Yu, J. Xie, J. Yang, H. Huang, K. Wang, Z. Wen, Lithium storage in conductive sulfur-containing polymers, J. Electroanal. Chem. 2004, 573, 121.
11. Tae Hoon Hwang, Dae Soo Jung, Joo-Seong Kim, Byung Gon Kim, and Jang Wook Choi, One-Dimensional Carbon-Sulfur Composite Fibers for Na—S Rechargeable Batteries Operating at Room Temperature, Nano Lett. 2013, 13, 9, 4532-4538.
12. J. Wang, J. Yang, C. Wan, K. Du, J. Xie, Sulfur Composite Cathode Materials for Rechargeable Lithium Batteries, Advanced Functional Materials, 2003, 13, 487-492.
13. Hwang, T. H., Jung, D. S., Kim, J. S., Kim, B. G. & Choi, J. W. One dimensional carbon-sulfur composite fibers for Na—S rechargeable batteries operating at room temperature. Nano Lett. 13, 4532-4538 (2013).
14. Wei, S., Ma, L., Hendrickson, K. E., Tu, Z. & Archer, L. A. Metal-sulfur battery cathodes based on PAN-sulfur composites. J. Am. Chem. Soc. 137, 12143-12152 (2015).
15. Shuya Wei, Lin Ma, Kenville E. Hendrickson, Zhengyuan Tu, and Lynden A. Archer, Metal-Sulfur Battery Cathodes based on PAN-Sulfur Composites, J. Am. Chem. Soc. 2015, 137, 37, 12143-12152.
16. Wenxi Wang, Zhen Cao, Giuseppe Antonio Elia, yingqiang Wu, Wandi Wahyudi, Edy Abou-Hamad, Abdul-Hamid Emwas, Luigi Cavallo, Lain-Jong Li, and Jun Ming, Recognizing the Mechanism of Sulfurized Polyacrylonitrile Cathode Material for Li—S Battery and beyond in Al—S battery, ACS Energy Lett. 2018, 3, 12, 2899-2907.

1. A method of making a cathode active material, comprising steps of:
a) mixing a conductive polymer, a nitrogen-containing polymer, or a combination of a conductive polymer and a nitrogen-containing polymer with sulfur in the presence of a solvent to form a mixture, wherein a weight ratio of the conductive polymer and/or nitrogen containing polymer to the sulfur is from about 1:2 to about 1:8; and
b) heating the mixture to a temperature of from about 250° C. to about 400° C. under a pressure of from about 0.05 bar to about 2.0 bar to form the cathode active material.

2. The method of claim 1, wherein the heating step is carried out for about 1 to about 10 hours.

3. The method of claim 1, wherein a dopant selected from the group consisting of magnesium, iron, cobalt, nickel, molybdenum, and iodine and mixtures thereof, is added to the mixture prior to or during the heating step.

4. The method of claim 1, wherein the heating step is a step of pyrolysis.

5. The method of claim 1, wherein the pressure is from about 0.1 to about 1.5 bar during the heating step.

6. The method of claim 1, wherein gas is vented during the heating step to control the pressure.

7. The method of claim 1, wherein the heating step is carried out in a closed reactor without venting gas from the reactor during the heating step.

8. The method of claim 1, wherein the cathode active material has a sulfur loading of at least 35 wt. %, based on a total weight of the cathode active material.

9. The method of claim 1, wherein the cathode active material has a stable capacity of greater than about 450 mAh/g, based on a total weight of the cathode active material.

10. The method of claim 1, wherein the conductive polymer is selected from the group consisting of polypyrrole, polyyne, polythiophenes, poly(3,4-ethylenedioxythiophene) polystyrene sulfonate (PEDOT), and nitrogen-containing polymers, selected from polyamide, polyaniline, and poly(nitroaniline), polyurethane, poly(phenyl sulfide-tetra aniline), and mixtures thereof.

11-14. (canceled)

15. A cathode electrode composite, comprising a cathode active material prepared by the method of claim 1, conductive carbon black or conductive microporous carbon, and one or more binders that are soluble in the solvent of claim 1.

16. The cathode electrode composite of claim 15, wherein the one or more binders is selected from the group consisting of sodium carboxy methyl cellulose, Beta cyclodextrin, poly acrylic acid, polymethacrylic acid, carboxyethyl cellulose, acrylic acid-methacrylic acid copolymer, polyvinylidene fluoride, polyvinylidene difluoride, and mixtures thereof.

17. The cathode electrode composite of claim 15, wherein the cathode active material, the conductive carbon black, and the binder are present in a weight ratio of from 60:30:10 to 90:5:5.

18. The cathode electrode composite of claim 15, having a sulfur loading of from about 50 wt. % to about 80 wt. %, based on a total weight of the cathode electrode composite.

19. The cathode electrode composite of claim 18, wherein the cathode electrode composite has a stable capacity of from 500 mAh/g to about 850 mAh/g, at 0.5 C, based on a total weight of the cathode electrode composite.

20. The cathode electrode composite of claim 15, comprising sulfur particles having a particle size ranging from 50 nm-500 nm, as measured by scanning electron microscopy or Dynamic Light Scattering.

21. A sulfur cell comprising the cathode electrode composite of claim 15, an anode, and an electrolyte.

22. The sulfur cell of claim 21, wherein the electrolyte is a carbonate electrolyte carbonate.

23. The sulfur cell of claim 21, wherein the anode is an ion reservoir including an active material selected from the group consisting of alkali metals, alkaline earth metals, transition metals, graphite, alloys, composites and mixtures thereof.

24. (canceled)

25. The sulfur cell of claim 21, wherein the cell is selected from the group consisting of a lithium-sulfur cell, a sodium-sulfur cell, a potassium-sulfur cell, a magnesium-sulfur cell, and a calcium-sulfur cell.

26. A battery comprising one or more of the sulfur cells according to claim 21.

27. (canceled)
